(19) United States
(12) Patent Application Publication
(10) Pub. No.: US 2014/0250007 A1
(43) Pub. Date: Sep. 4, 2014

(54) METHOD AND SYSTEM OF COOKIE DRIVEN CARDHOLDER AUTHENTICATION SUMMARY

(71) Applicant: MASTERCARD INTERNATIONAL INCORPORATED, (US)

(72) Inventor: Justin Xavier HOWE, Oakdale, NY (US)

(73) Assignee: MASTERCARD INTERNATIONAL INCORPORATED, Purchase, NY (US)

(21) Appl. No.: 13/782,680

(22) Filed: Mar. 1, 2013

(51) Int. Cl. G06Q 20/40

(52) U.S. Cl. CPC G06Q 20/409
USPC 705/44

(57) ABSTRACT

A method for authenticating a financial transaction includes: storing a plurality of transaction data entries, each transaction data entry including data related to a financial transaction and including transaction data and a consumer identifier; receiving cookie data, the cookie data including a computing device identifier and historical browsing data; receiving an authorization request for a financial transaction, the authorization request including a consumer identification; identifying, in the transaction database, a subset of transaction data entries, wherein each transaction data entry in the subset includes a consumer identifier corresponding to the consumer identification; identifying an authentication score for the financial transaction based on a correlation of transaction data included in each transaction data entry of the subset and the historical browsing data; and transmitting the identified authentication score and consumer identification for use in approval of the financial transaction by an issuer.

### FIELD

The present disclosure relates to the use of cookie data for authentication of a financial transaction, specifically using cookie data in combination with historical transaction data to provided added authentication for a financial transaction.

### BACKGROUND

As the Internet developed and started to gain widespread use, it began to be used more and more as a platform for electronic commerce. With more advanced technology, the Internet became available on more devices and by extension for more consumers, increasing the amount of business conducted using the Internet. However, as the volume of Internet transactions increased, so did the volume of fraudulent transactions. In traditional face-to-face transactions, merchants could ask a consumer paying with a payment card (e.g., a credit card) for additional identification to verify that the consumer is genuine. However, with Internet transactions, online retailers are limited in terms of what information can be requested from the consumer.

As a result, many merchants, retailers, and service providers have attempted to develop methods for increased fraud detection to protect both consumers and merchants. Some methods included identifying an internet protocol (IP) address of a consumer, and then identifying a geographic area from which the IP address originates, which may be used to detect a fraudulent transaction in some instances, such as if a payment card is used in a physical (e.g., face-to-face) transaction in one location and then used in an Internet transaction shortly thereafter with an IP address thousands of miles away. However, because of proxies and other such tools, a person committing fraud may be able to mask their IP address such that it appears to originate from a location near the cardholder, thus rendering authentication via the IP address ineffective.

Other methods include identifying a consumer fingerprint, which refers to a combination of a significant number of browser details, such as identifying the browser and version, Java® version, Flash® version, operating system and version, browser plugins, etc. The consumer fingerprint may be identified when an account holder conducts an Internet transaction with a specific payment account, and then may be identified again in a subsequent transaction with that payment account. The fingerprint in the subsequent transaction may be compared to the previously identified fingerprint, which may indicate that the person attempting to use the payment account is not the account holder if the fingerprint is different. However, many consumers regularly use multiple computing devices and on those devices may use multiple browsers. As such, the use of a consumer fingerprint has become less effective as the use of multiple computing devices, such as desktop computers, laptop computers, tablet computers, and smart phones, for conducting payment transactions has increased.

Thus, there is a need for a technical solution to providing added authentication to Internet-based consumer payment transactions.

### SUMMARY

The present disclosure provides a description of a system and method for the authentication of a financial transaction utilizing cookie data and financial transaction history.

A method for authenticating a financial transaction includes: storing, in a transaction database, a plurality of transaction data entries, wherein each transaction data entry of the plurality of transaction data entries includes data related to a financial transaction and includes at least transaction data and a consumer identifier; receiving, by a first receiving device, cookie data, wherein the cookie data includes at least a computing device identifier and historical browsing data; receiving, by a second receiving device, an authorization request for a financial transaction, wherein the authorization request includes at least a consumer identification; identifying, in the transaction database, a subset of transaction data entries, wherein each transaction data entry in the subset of transaction data entries includes a consumer identifier corresponding to the consumer identification; identifying, by a processing device, an authentication score for the financial transaction based on a correlation of transaction data included in each transaction data entry of the subset of transaction data entries and the historical browsing data; and transmitting, by a transmitting device, at least the identified authentication score and consumer identification for use in approval of the financial transaction by an issuer.

A system for authenticating a financial transaction includes a transaction database, a first receiving device, a second receiving device, a processing device, and a transmitting device. The transaction database is configured to store a plurality of transaction data entries, wherein each transaction data entry of the plurality of transaction data entries includes data related to a financial transaction and includes at least transaction data and a consumer identifier. The first receiving device is configured to receive cookie data, wherein the cookie data includes at least a computing device identifier and historical browsing data. The second receiving device is configured to receive an authorization request for a financial transaction, wherein the authorization request includes at least a consumer identification. The processing device is configured to identify, in the transaction database, a subset of transaction data entries, wherein each transaction data entry in the subset of transaction data entries includes a consumer identifier corresponding to the consumer identification, and identify an authentication score for the financial transaction based on a correlation of transaction data included in each transaction data entry of the subset of transaction data entries and the historical browsing data. The transmitting device is configured to transmit at least the identified authentication score and consumer identification for use in approval of the financial transaction by an issuer.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the authentication of financial transactions using cookie data and transaction history and changes therein.

FIG. 2 is a block diagram illustrating an embodiment of a processing server for use in the system of FIG. 1 in accordance with exemplary embodiments.

FIGS. 3A and 3B are a flow diagram illustrating a method for cookie-based authentication of a financial transaction in accordance with exemplary embodiments.

FIG. 4 is a diagram illustrating the identification of a correlation between transaction data and historical browsing data in accordance with exemplary embodiments.

FIG. 5 is a flow chart illustrating an exemplary method for authenticating a financial transaction in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Identifying Merchant Debit Routing Tables

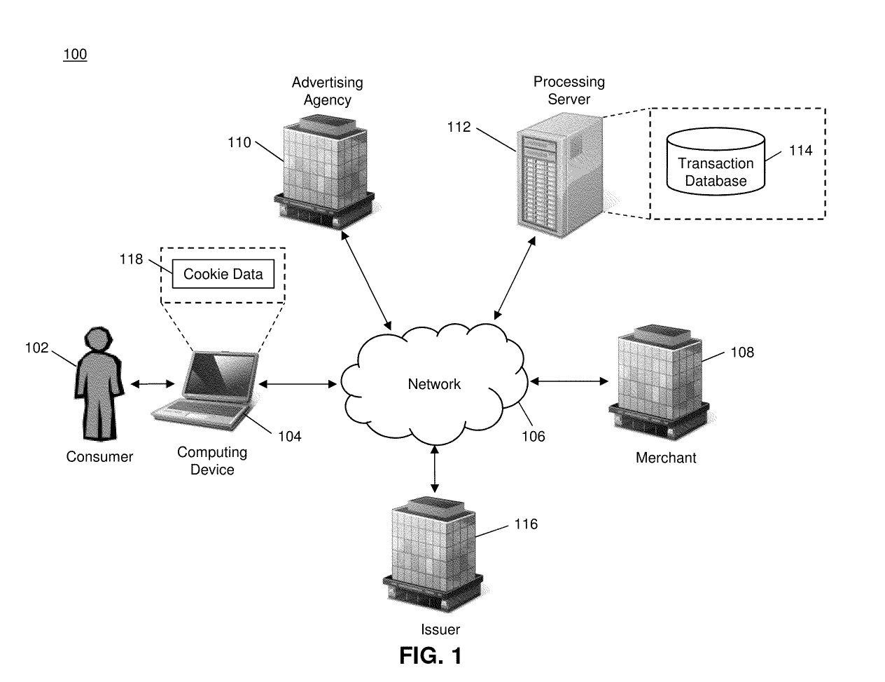

FIG. 1 is a block diagram illustrating a system 100 for the cookie-based authentication of financial transactions. In the system 100, a consumer 102 may use a computing device 104 to connect to a network 106. The computing device 104 may be any computing device suitable for connecting to and/or browsing a network, such as a desktop computer, laptop computer, notebook computer, tablet computer, cellular phone, smart phone, etc. The network 106 may be the Internet, or any other network suitable for use in conducting electronic payment transactions.

The consumer 102 may navigate, via the computing device 104, to a webpage operated by or on behalf of a merchant 108. The computing device 104 may store cookie data 118 based on the browsing of the consumer 102 and/or the merchant webpage. For example, the merchant webpage may include programming code configured to cause the computing device 104 to store specific cookie data 118. In some embodiments, the merchant webpage may display advertising or other content providing by an advertising agency 110, which may be configured to use the cookie data 118 to track the browsing history of the consumer 102 across multiple websites. Methods and systems for the use of cookie data 118 to track browsing history of consumers will be apparent to persons having skill in the relevant art.

At the merchant webpage, the consumer 102 may initiate a financial transaction with the merchant 108 for the purchase of goods and/or services. When the consumer 102 initiates the transaction, the computing device 104 may transmit the cookie data 108 to a processing server 112. In some embodiments, the merchant webpage may be including programming code that instructs a web browsing application on the computing device 104 to transmit the cookie data 118 to the processing server 112. In other embodiments, the merchant 108 may read the cookie data 118 from the computing device 104 and may transmit the cookie data to the processing server 112 via the network 106. In an alternative embodiment, the processing server 112 may receive the cookie data 118 from the advertising agency 110. In an exemplary embodiment, the cookie data 118 includes an identifier identifying the computing device 104, such as a media access control (MAC) address.

The consumer 102 may use a payment card to fund the financial transaction. The payment card may be issued to the consumer 102 by an issuer 116, such as an issuing bank. The merchant 108, or an acquirer on behalf of the merchant 108, such as an acquiring bank, may submit an authorization request (e.g., via the network 106) for the financial transaction to a payment network.

The payment network may include the processing server 112. In some embodiments, the processing server 112 may be external to the payment network, but may communicate directly or indirectly (e.g., via the network 106) with the payment network for providing an authentication score for use in authenticating the financial transaction. The processing server 112, discussed in more detail below, may include a transaction database 114. The transaction database 114 may be configured to store a plurality of transaction data entries, discussed in more detail below, each transaction data entry including data related to a financial transaction including at least transaction data and a consumer identifier.

The payment network may forward transaction information to the processing server 112, wherein the transaction information includes at least a consumer identification. The processing server 112 may identify a subset of the transaction data entries included in the transaction database 114 for transactions involving the consumer 102 based on the consumer identification, and may identify a correlation, discussed in more detail below, between the financial transactions in the subset and browsing history included in the previously received cookie data 118. The correlation may show, for example, that the consumer 102 conducted financial transactions at certain times, and that the computing device 104 visited websites for the corresponding merchants at similar times. This correlation may indicate that the consumer 102 is the one initiating the financial transaction with the merchant 108, which may provide stronger authentication. The processing server 112 may then identify an authentication score based on the identified correlation.

The processing server 112 may then transmit the identified authentication score to the payment network or directly to the issuer 118 for use in approving or denying the financial transaction. The use of the authentication score may improve the authentication of consumers conducting payment transaction over the Internet and other forms of electronic commerce. While traditional methods for detecting fraud in Internet transactions focus on identifying if a consumer is a criminal (e.g., not the account holder), the present system and method focus on identifying that the consumer is in fact the account holder. The positive filtering of the consumer rather than negative filtering may result in a stronger, more effective authentication. Furthermore, the use of the cookie data 118, which may be obtained directly from advertising agencies 110 or other third parties that are already configured to obtain historical browsing data, may enable stronger authentication without any necessary modifications to legacy payment systems of the merchant 108 or the issuer 116.

### Processing Server

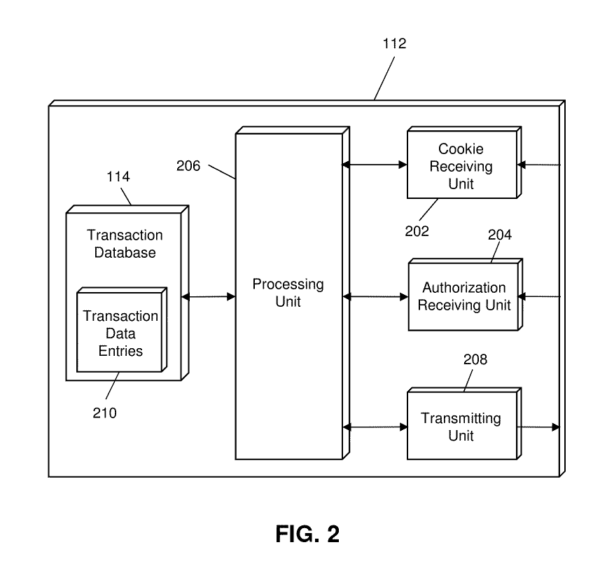

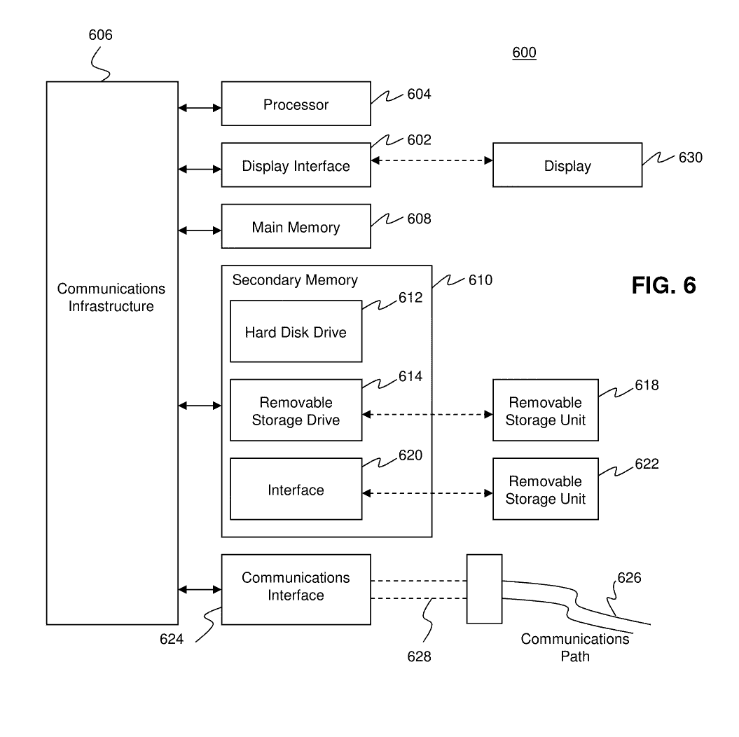

FIG. 2 illustrates an embodiment of the processing server 112 of the system 100. It will be apparent to persons having skill in the relevant art that the embodiment of the processing server 112 illustrated in FIG. 2 is provided as illustration only and may not be exhaustive to all possible configurations of the processing server 112 suitable for performing the functions as discussed herein. For example, the computer system 600 illustrated in FIG. 6 and discussed in more detail below may be a suitable configuration of the processing server 112.

The processing server 112 may include the transaction database 114, which may be configured to store a plurality of transaction data entries 210. Each transaction data entry 210 may include data related to a financial transaction and include at least transaction data and a consumer identifier. The transaction data may be information related to the financial transaction suitable for performing the functions as disclosed herein, such as a time and/or date, a merchant name or identification, product details, etc. The consumer identifier may be a unique value used for the identification of a consumer (e.g., the consumer 102). Values suitable for use as the consumer identifier will be apparent to persons having skill in the relevant art and may include a payment account number, a username, an e-mail address, a phone number, or a computing device identifier (e.g., a MAC address).

The processing server 112 may include a cookie receiving unit 202. The cookie receiving unit 202 may be configured to receive the cookie data 118, wherein the cookie data 118 includes at least a computing device identifier (e.g., corresponding to the computing device 104) and historical browsing data. Information included in the historical browsing data will be apparent to persons having skill in the relevant art.

The processing server 112 may also include an authorization receiving unit 204. It will be apparent to persons having skill in the relevant art that, in some embodiments, the cookie receiving unit 202 and the authorization receiving unit 204 may be a single device. The authorization receiving unit 204 may be configured to receive an authorization request for a financial transaction, the authorization request including at least a consumer identification. The processing server 112 may also include a processing unit 206, which may be configured to identify a subset of transaction data entries 210 where the included consumer identifier corresponds to the consumer identification included in the authorization request.

The processing unit 206 may also identify a correlation, discussed in more detail below, between the transaction data included in each transaction data entry 210 in the subset of transaction data entries and the historical browsing data included in the cookie data 118. In some embodiments, the transaction data entries 210 may further included a computing device identifier, and the processing unit 206 may identify the correlation between the historical browsing data and those transaction data entries 210 including the computing device identifier included in the cookie data 118.

The processing unit 206 may be further configured to identify an authentication score based on the identified correlation. The authentication score may be an indication of the likelihood that the consumer involved in the financial transaction corresponding to the authorization request is the account holder for the payment account used to fund the financial transaction. The processing server 112 may also include a transmitting unit 208, which may be configured to transmit the identified authentication score and consumer identification, which may be used by the issuer 116 of the payment account used to fund the financial transaction for approving or denying the financial transaction.

### Method for Cookie-Based Authentication of a Financial Transaction

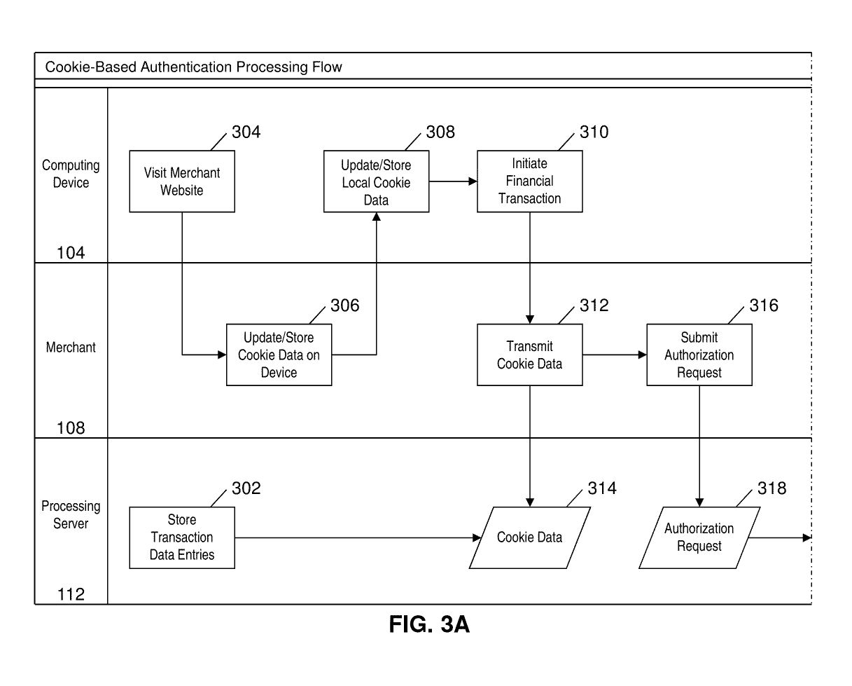

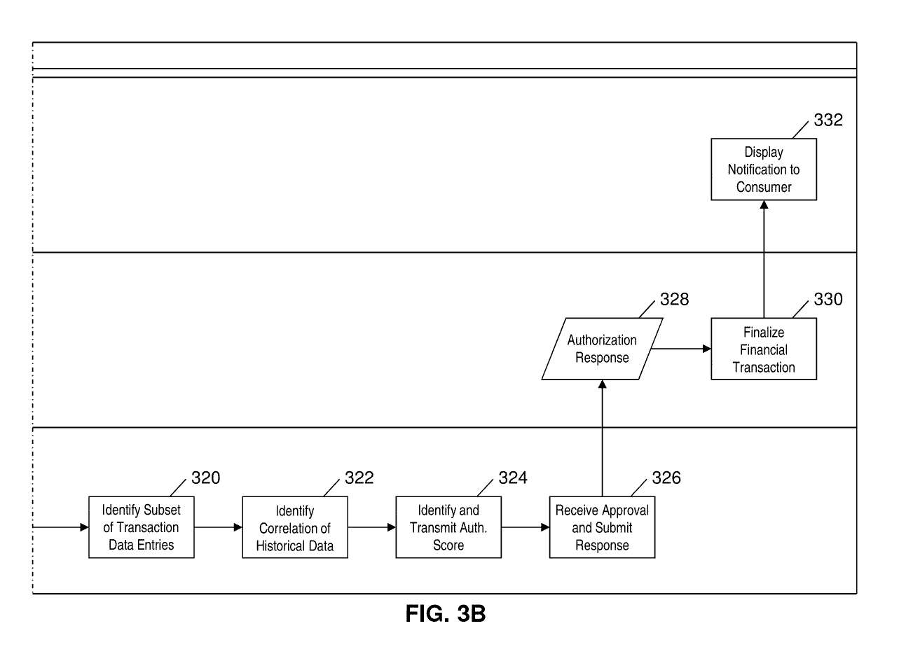

FIGS. 3A and 3B are a process flow illustrating a method for cookie-based authentication.

In step 302, the processing server 112 may store, in the transaction database 114, a plurality of transaction data entries, wherein each transaction data entry 210 includes data related to a financial transaction and includes at least transaction data and a consumer identifier. In step 304, the consumer 102 may visit a website operated by or on behalf of the merchant 108 via the computing device 104.

When the consumer 102 visits the website, the merchant 108, or a third party operating on behalf of the merchant 108 such as the advertising agency 110, may cause the computing device 104 to update or store cookie data 118 in step 306. The cookie data 118 may include information identifying the website accessed by the computing device 104. In step 308, the computing device 104 may store or update the local cookie data 118 on the computing device 104 in response to the instructions (e.g., commands) received from the merchant 108. Methods for storing or updating cookie data 118 locally stored in a computing device will be apparent to persons having skill in the relevant art.

In step 310, the consumer 102 may initiate a financial transaction with the merchant 108 over the network 106 using the computing device 104. Methods for initiating a financial transaction using a webpage on a network 106 (e.g., the Internet) will be apparent to persons having skill in the relevant art. For example, the consumer 102 may interact with (e.g., click on) a “checkout” button displayed on the merchant webpage.

Once the consumer 102 has initiated the financial transaction, the merchant 108 may transmit the cookie data 118 to the processing server 112 in step 312. In one embodiment, the merchant webpage may instruct (e.g., command) the computing device 104 to transmit the cookie data 118 to the processing server 112. In another embodiment, the merchant webpage may read the cookie data 118 from the computing device 104 and may transmit it to the processing server 112. In yet another embodiment, the cookie data 118 may be obtained by the advertising agency 110 (e.g., via ads placed on a plurality of merchant websites) and transmitted to the processing server 112 by request of the merchant 108. In another embodiment, the merchant 108 may notify the processing server 112 of the initiated financial transaction and the processing server 112 may request the cookie data 118 from the advertising agency 110 (e.g., identified via the computing device identifier).

In step 314, the processing server 112 may receive the cookie data 118 including the historical browsing data. In step 316, the merchant 108 may submit an authorization request to the processing server 112 for the financial transaction. In one embodiment, the authorization request may be submitted to a payment network, which may then forward the authorization request or a part thereof to the processing server 112. In step 318, the processing server 112 may receive the authorization request including at least a consumer identification.

In step 320, the processing server 112 may identify a subset of the transaction data entries 210 where the consumer identifier in each transaction data entry 210 of the subset corresponds to the consumer identification included in the authorization request. Then, in step 322, the processing server 112 may identify correlation of the transaction data entries 210 in the subset and the historical browsing data. In step 324, the processing server 112 may identify an authorization score based on the identified correlation and transmit the authorization score for use in approval of the financial transaction by the issuer 116.

In step 326, the processing server 112 may receive a response indicating approval of the financial transaction from the issuer 116, and may generate and submit an authorization response to the merchant 108 (e.g., via the payment network if applicable). In step 328, the merchant 108 may receive the authorization response indicating approval of the financial transaction. Then, in step 330, the merchant 108 may finalize the financial transaction, which may include generating and/or transmitting a receipt, provisioning the transacted for goods or services to the consumer 102, etc. In step 332, the computing device 104 may display a notification of the finalization and/or approval of the financial transaction to the consumer 102. The notification may include a receipt for the transaction and/or a message or information provided by the merchant 108 (e.g., shipping information, return information, etc.).

### Correlation Between Transaction Data and Browsing Data

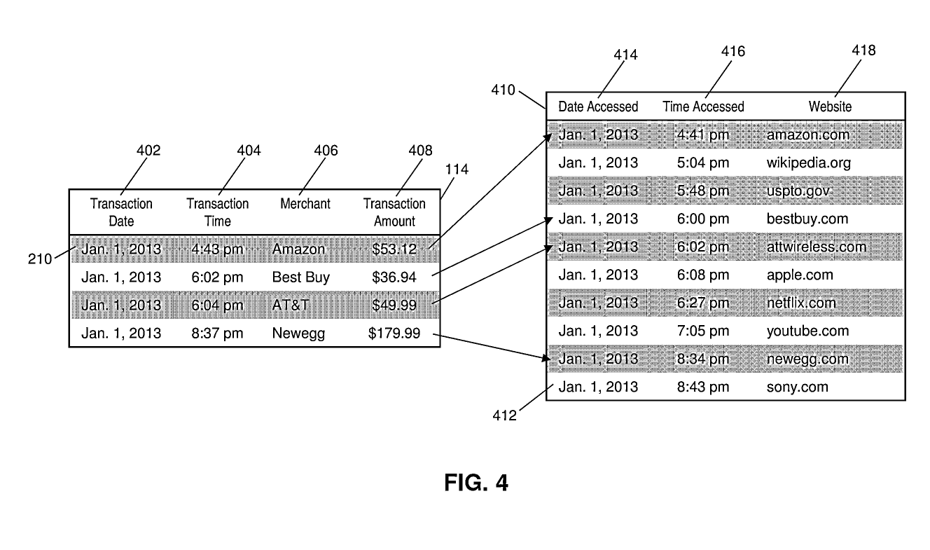

FIG. 4 is an illustration of transaction data stored in the transaction database 114 and historical browsing data included in the cookie data 118.

As illustrated in FIG. 4, the transaction database 114 may include the plurality of transaction data entries 210. Each transaction data entry 210 may include a transaction date 402, a transaction time 404, a merchant 406, and a transaction amount 408. It will be apparent to persons having skill in the relevant art that, although the transaction data entries 210 illustrated in FIG. 4 are all related to financial transactions involving a single consumer (e.g., the consumer 102), the transaction database 114 may include transaction data entries 210 related to financial transactions involving a plurality of different consumers.

The transaction date 402 and transaction time 404 may be the date and time when the related financial transaction took place. In some embodiments, the transaction date 402 and time 404 may be the time that an authorization request was submitted, the time that the authorization was approved, the time that the transaction cleared, or any other time and date suitable for performing the functions discussed herein. The merchant 406 may be a value identifying a merchant (e.g., the merchant 108) involved in the related financial transaction, such as a merchant identification number (MID). It will be apparent to persons having skill in the relevant art that the transaction amount 408 may be optional.

The cookie data 118 may include historical browsing data 410. The historical browsing data 410 may be a record of merchant websites accessed by the computing device 104. The historical browsing data 410 may include a plurality of browsing records 412, wherein each browsing record 412 includes a browsing time 416 and browsing date 414 at which a specific website 418 is accessed by the computing device 104. In some embodiments, the historical browsing data 410 may only include those websites 418 configured to update the cookie data 118 to include a browsing record 412 for that particular website. For example, the historical browsing data 410 may only include browsing records 412 for merchant websites that include specific programming code configured to store the browsing record 412 in a specific cookie, or merchant websites that include code provided by the advertising agency 110, which may display an advertisement and log the visit to the merchant website 418 in the historical browsing data 410. Methods for obtaining historical browsing data 410 will be apparent to persons having skill in the relevant art.

The processing server 112 may be configured to identify a correlation between the transaction data entries 210 in the transaction database 114 related to financial transactions involving the consumer 102 and the historical browsing data 410 of a computing device 104 being used by the consumer 102. The processing server 112 may identify browsing records 412 for around the same time on the same date as indicated for a transaction data entry 210. For example, as illustrated in FIG. 4, a transaction data entry 210 indicates that the consumer 102 conducted a financial transaction with Amazon at 4:43 pm on Jan. 1, 2013. The processing server 102 may then examine browsing records 412 on Jan. 1, 2013 around 4:43 pm. As indicated in the historical browsing data 410, the computing device 104 visited amazon.com, a website affiliated with Amazon, at 4:41 pm, just prior to the financial transaction.

The processing server 112 may use the correlation identified between the transaction data entries 210 and the browsing records 412 to identify an authentication score, which may indicate the likelihood that an initiated financial transaction is not fraudulent. In such an instance, if the processing server 112 identifies that there are no browsing records 412 corresponding to financial transactions involving the consumer 102, then an initiated financial transaction originating from a merchant website may be highly suspect as being initiated by someone other than the consumer 102. Conversely, if there are browsing records 412 corresponding to most or all financial transactions conducted by the consumer 102, then a financial transaction originating at a website 418 with a corresponding browsing record 412 is more likely to be initiated by the consumer 102 rather than an unauthorized party.

For example, as illustrated in FIG. 4, the historical browsing data 410 includes a browsing record 412 corresponding to each transaction data entry 210 in the transaction database. The payment network and/or the processing server 112 may receive an authorization request for a financial transaction involving the consumer 102 and Sony as the merchant 108. The processing server 102 may identify the strong correlation between the transaction data entries 210 and the historical browsing data, including a browsing record indicating that the computing device 104 visited a website 418 corresponding to Sony as the merchant 108. This may indicate a very strong likelihood that the financial transaction with Sony was initiated by the consumer 102, and thus the processing server 112 may identify an authentication score indicating the very strong likelihood, which may then be transmitted to the issuer 116 for use in approving the financial transaction.

Additional methods for identifying a correlation between conducted financial transactions and browsing history will be apparent to persons having skill in the relevant art. Methods suitable for scoring a financial transaction based on an identified correlation will also be apparent to persons having skill in the relevant art.

### Exemplary Method for Authenticating a Financial Transaction

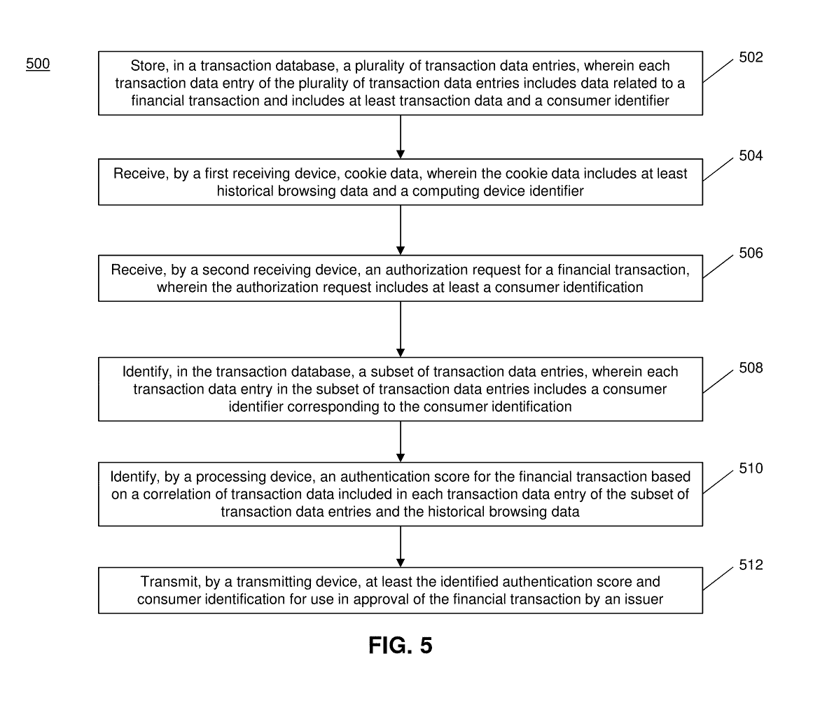

FIG. 5 illustrates a method 500 for authenticating a financial transaction using transaction data and browsing history.

In step 502, a plurality of transaction data entries may be stored in a transaction database (e.g., the transaction database 114), wherein each transaction data entry (e.g., the transaction data entry 210) may include data related to a financial transaction and may include at least transaction data and a consumer identifier. In some embodiments, the transaction data may include at least one of: transaction amount (e.g., the transaction amount 408), transaction time (e.g., the transaction time 404) and/or transaction date (e.g., the transaction date 402), payment method, shipping method, merchant identifier, product details, invoice number, purchase number, and purchase website. In one embodiment, the consumer identifier may be a payment account number. In another embodiment, the consumer identifier may correspond to a computing device (e.g., the computing device 104).

In step 504, a first receiving device (e.g., the cookie receiving unit 202) may receive cookie data (e.g., the cookie data 118), wherein the cookie data includes at least historical browsing data (e.g., the historical browsing data 410) and a computing device identifier. In embodiments where the consumer identifier may correspond to a computing device 104, the cookie data 118 may originate from the computing device 104. In step 506, a second receiving device (e.g., the authorization receiving unit 204) may receive an authorization request for a financial transaction, wherein the authorization request includes at least a consumer identification. In one embodiment, the cookie data 118 may be included in the authorization request. In some embodiments, the first receiving device 202 and the second receiving device 204 may be a single device. In some embodiments, the authorization request may further include a computing device identification, and the computing device identification may correspond to the computing device identifier.

In step 508, a subset of transaction data entries may be identified in the transaction database 114, wherein each transaction data entry 210 in the subset of transaction data entries includes a consumer identifier corresponding to the consumer identification. In step 510, an authentication score for the financial transaction may be identified, by a processing device (e.g., the processing unit 206), based on a correlation of transaction data included in each transaction data entry 210 of the subset of transaction data entries and the historical browsing data 410. In some embodiments, each transaction data entry 210 may include a merchant identifier (e.g., the merchant 406), the historical browsing data 410 may include a plurality of merchant websites (e.g., the website 418), and the correlation may include the correlation of merchant identifiers 406 in the transaction data entries 210 in the subset to the merchant websites 418 in the historical browsing data 410.

In step 512, a transmitting device (e.g., the transmitting unit 208) may transmit at least the identified authentication score and consumer identification for use in approval of the financial transaction by an issuer (e.g., the issuer 116). In embodiments where the consumer identifier may be a payment account number, the issuer 116 may be associated with the payment account number. In some embodiments, the transmitting step 512 may include transmitting the authorization request to the issuer 116, the authorization request further including the authentication score. In one embodiment, the method 500 may further include receiving, by the first 202 or second 204 receiving device, an indication of approval of the financial transaction by the issuer 116, and transmitting, by the transmitting device 208, an authorization response, wherein the authorization response indicates approval of the financial transaction.

### Computer System Architecture

FIG. 6 illustrates a computer system 600 in which embodiments of the present disclosure, or portions thereof, may be implemented as computer-readable code. For example, the computing device 104, the merchant 108, and the processing server 112 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communication infrastructure 606, such as a bus, message queue, network, multi-core message-passing scheme, etc. The network (e.g., the network 106) may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive, the removable storage unit 618 may be a floppy disk. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

Computer program medium and computer usable medium may refer to memories, such as the main memory 608 and secondary memory 610, which may be memory semiconductors (e.g. DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3A, 3B, and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, a system and method for authenticating a financial transaction. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for authenticating a financial transaction, comprising:
storing, in a transaction database, a plurality of transaction data entries, wherein each transaction data entry of the plurality of transaction data entries includes data related to a financial transaction and includes at least transaction data and a consumer identifier;
receiving, by a first receiving device, cookie data, wherein the cookie data includes at least a computing device identifier and historical browsing data;
receiving, by a second receiving device, an authorization request for a financial transaction, wherein the authorization request includes at least a consumer identification;
identifying, in the transaction database, a subset of transaction data entries, wherein each transaction data entry in the subset of transaction data entries includes a consumer identifier corresponding to the consumer identification;
identifying, by a processing device, an authentication score for the financial transaction based on a correlation of transaction data included in each transaction data entry of the subset of transaction data entries and the historical browsing data; and
transmitting, by a transmitting device, at least the identified authentication score and consumer identification for use in approval of the financial transaction by an issuer.

2. The method of claim 1, wherein the cookie data is included in the authorization request.

3. The method of claim 1, wherein
each transaction data entry further includes a merchant identifier,
the historical browsing data includes a plurality of merchant websites, and
the correlation of transaction data and the historical browsing data includes the correlation of merchant identifiers included in the transaction data entries of the subset of transaction data entries to merchant websites of the plurality of merchant websites.

4. The method of claim 1, further comprising:
receiving, by the first or second receiving device, an indication of approval of the financial transaction by the issuer; and
transmitting, by the transmitting device, an authorization response, wherein the authorization response indicates approval of the financial transaction.

5. The method of claim 1, wherein the transaction data includes at least one of: transaction amount, transaction time and/or date, payment method, shipping method, merchant identifier, product details, invoice number, purchase number, and purchase website.

6. The method of claim 1, wherein the consumer identifier is a payment account number.

7. The method of claim 6, wherein the issuer is associated with the payment account number.

8. The method of claim 1, wherein the consumer identifier corresponds to a computing device.

9. The method of claim 8, wherein the received cookie data originates from the computing device corresponding to the consumer identifier.

10. The method of claim 1, wherein the transmitting step includes transmitting the authorization request to the issuer, the authorization request further including the identified authentication score.

11. The method of claim 1, wherein the first receiving device and the second receiving device are a single device.

12. The method of claim 1, wherein the authorization request further includes a computing device identification, and wherein the computing device identification corresponds to the computing device identifier.

13. A system for authenticating a financial transaction, comprising:
a transaction database configured to store a plurality of transaction data entries, wherein each transaction data entry of the plurality of transaction data entries includes data related to a financial transaction and includes at least transaction data and a consumer identifier;
a first receiving device configured to receive cookie data, wherein the cookie data includes at least historical browsing data and a computing device identifier;
a second receiving device configured to receive an authorization request for a financial transaction, wherein the authorization request includes at least a consumer identification;
a processing device configured to
identify, in the transaction database, a subset of transaction data entries, wherein each transaction data entry in the subset of transaction data entries includes a consumer identifier corresponding to the consumer identification, and
identify an authentication score for the financial transaction based on a correlation of transaction data included in each transaction data entry of the subset of transaction data entries and the historical browsing data; and
a transmitting device configured to transmit at least the identified authentication score and consumer identification for use in approval of the financial transaction by an issuer.

14. The system of claim 13, wherein the cookie data is included in the authorization request.

15. The system of claim 13, wherein
each transaction data entry further includes a merchant identifier,
the historical browsing data includes a plurality of merchant websites, and
the correlation of transaction data and the historical browsing data includes the correlation of merchant identifiers included in the transaction data entries of the subset of transaction data entries to merchant websites of the plurality of merchant websites.

16. The system of claim 13, wherein
the first or second receiving device is further configured to receive an indication of approval of the financial transaction by the issuer, and
the transmitting device is further configured to transmit an authorization response, wherein the authorization response indicates approval of the financial transaction.

17. The system of claim 13, wherein the transaction data includes at least one of: transaction amount, transaction time and/or date, payment method, shipping method, merchant identifier, product details, invoice number, purchase number, and purchase website.

18. The system of claim 13, wherein the consumer identifier is a payment account number.

19. The system of claim 18, wherein the issuer is associated with the payment account number.

20. The system of claim 13, wherein the consumer identifier corresponds to a computing device.

21. The system of claim 20, wherein the received cookie data originates from the computing device corresponding to the consumer identifier.

22. The system of claim 13, wherein the transmitting device is further configured to transmit the authorization request to the issuer, the authorization request further including the identified authentication score.

23. The system of claim 13, wherein the first receiving device and the second receiving device are a single device.

24. The system of claim 13, wherein the authorization request further includes a computing device identification, and wherein the computing device identification corresponds to the computing device identifier.
